(19) United States
(12) Patent Application Publication
(10) Pub. No.: US 2021/0065548 A1
(43) Pub. Date: Mar. 4, 2021

(54) SYSTEMS AND METHODS FOR NAVIGATION BASED ON INTERSECTION CODING

(71) Applicant: BEIJING DIDI INFINITY TEHNOLOGY AND DEVELOPMENT CO., LTD., Beijing (CN)

(72) Inventor: Yan LI, Beijing (CN)

(73) Assignee: BEIJING DIDI INFINITY TECHNOLOGY AND DEVELOPMENT CO., LTD., Beijing (CN)

(21) Appl. No.: 17/098,472

(22) Filed: Nov. 16, 2020

Related U.S. Application Data
(63) Continuation of application No. PCT/CN2019/089564, filed on May 31, 2019.

(30) Foreign Application Priority Data
Jun. 1, 2018 (CN) 201810554414.7

(51) Int. Cl. G08G 1/0968; G08G 1/0969

(52) U.S. Cl. CPC G08G 1/096833; G08G 1/0969

(57) ABSTRACT

The present disclosure provides systems and methods for navigation based on intersection coding. A method may include obtaining a current location of a subject and navigation information. The method may also include determining, based on the current location and the navigation information, one or more road features associated with an upcoming intersection with respect to a current road segment. The method may also include determining, based on the one or more road features and a coding system, one or more navigation codes corresponding to the upcoming intersection. The method may further include determining, based on the one or more navigation codes, a prompt for navigation associated with the upcoming intersection.

### CROSS-REFERENCE TO RELATED APPLICATIONS

This application is a continuation of International Application No. PCT/CN2019/089564, filed on May 31, 2019, which claims priority of Chinese Patent Application No. 201810554414.7 filed on Jun. 1, 2018, the entire contents of each of which are hereby incorporated by reference.

### TECHNICAL FIELD

The present disclosure generally relates to systems and methods for navigation, and in particular, to systems and methods for navigation based on intersection coding.

### BACKGROUND

With construction of roads and rapid increase of the number of vehicles in cities, driving, as compared to taxi riding or using public transportation, has become more and more prevalent. If a user needs to know the roads or find the destination when travelling, the user can usually obtains navigation guidance through a terminal device (also referred to as a navigation device) equipped with a navigation application. In some cases, the navigation device stores and/or downloads navigation data from a cloud platform for performing a navigation. When a user uses the navigation device for navigation, the navigation device may first obtain a current location and a destination, and then determine a navigation path associated with the destination based on the stored and/or downloaded navigation data for the user, thereby allowing the user to arrive at the destination according to the navigation path. In a common navigation process, when the user approaches an intersection in the navigation path, the navigation device may provide a prompt to the user for crossing the intersection, such as “turn left,” “turn right,” “go straight,” etc. However, some intersections are connected with a plurality of road segments. For example, when the user needs to travel to the left front, there are two or more roads in the left front. A navigation cannot be performed accurately through a simple prompt such as “travel to the left front,” “travel to right front,” “turn left and take the left front road,” “turn right and take the right front road,” etc. Therefore, it may be desired to provide systems and methods for providing a more precise navigation strategy.

### SUMMARY

According to a first aspect of the present disclosure, a system for navigation based on intersection coding is provided. The system may include at least one storage medium and at least one processor in communication with the at least one storage medium. The at least one storage medium may include a set of instructions. When the at least one processor executes the set of instructions, the at least one processor may be configured to perform one or more of the following operations. The at least one processor may be configured to cause the system to obtain a current location of a subject and navigation information. The at least one processor may be configured to cause the system to determine, based on the current location and the navigation information, one or more road features associated with an upcoming intersection with respect to a current road segment. The at least one processor may be configured to cause the system to determine, based on the one or more road features and a coding system, one or more navigation codes corresponding to the upcoming intersection. The at least one processor may be configured to cause the system to determine, based on the one or more navigation codes, a prompt for navigation associated with the upcoming intersection.

In some embodiments, wherein the coding system may provide a mapping relationship between a plurality of specific road features and a plurality of specific navigation codes. Each of the plurality of specific navigation codes may correspond to a specific prompt for navigation, and the prompt for navigation may be selected from the specific prompts.

In some embodiments, the one or more road features may include at least one of one or more attributes of a road associated with the upcoming intersection, a location relationship between a target road segment that the subject travels to and the current road segment, a count of one or more interference roads on the left of the target road segment, or a count of one or more interference roads on the right of the target road segment.

In some embodiments, to determine the mapping relationship between the plurality of specific road features and the plurality of specific navigation codes, the at least one processor may be configured to cause the system to determine a plurality of combinations of the plurality of specific road features. In some embodiments, to determine the mapping relationship between the plurality of specific road features and the plurality of specific navigation codes, the at least one processor may further be configured to cause the system to determine one of the plurality of specific navigation codes corresponding to each of the plurality of combinations of the plurality of specific road features.

In some embodiments, to determine the one or more road features, the at least one processor may be configured to cause the system to for the upcoming intersection, determine, based on the current road segment, a multidirectional coordinate system. In some embodiments, to determine the one or more road features, the at least one processor may be configured to cause the system to determine a target region that the target road segment belongs to in the multidirectional coordinate system. In some embodiments, to determine the one or more road features, the at least one processor may be configured to cause the system to determine, based on the target region, the one or more road features.

In some embodiments, to determine, based on the target region, the one or more road features, the at least one processor may be configured to cause the system to determine a count of one or more road segments that the subject can travel to on either of two sides of the target road segment, respectively, as the count of interference roads on the left of the target road segment and the count of interference roads on the right of the target road segment, wherein the one or more road segments belongs to the target region.

In some embodiments, the multidirectional coordinate system may include eight directions.

In some embodiments, the prompt for navigation may include at least one of an image, a voice, or a text.

In some embodiments, the at least one processor may be further configured to cause the system to send signals to a client terminal to direct the client terminal to display the prompt for navigation.

In some embodiments, the at least one processor may be further configured to cause the system to determine whether an attribute of the current road segment includes a roundabout entrance. In some embodiments, the at least one processor may be further configured to cause the system to in response to a determination that the attribute of the current road segment does not include the roundabout entrance, determine, based on the one or more road features and the coding system, the one or more navigation codes corresponding to the upcoming intersection.

In some embodiments, the at least one processor may be further configured to cause the system to determine whether the navigation information includes a switch between a main road and a side road. In some embodiments, the at least one processor may be further configured to cause the system to in response to a determination that the navigation information includes the switch between the main road and the side road, adjust the prompt for navigation.

According to a second aspect of the present disclosure, a method for navigation based on intersection coding is provided. The method may be implemented on at least one computing device, each of which may include at least one processor and a storage device. The method may include one or more of the following operations. The method may include obtaining a current location of a subject and navigation information. The method may also include determining, based on the current location and the navigation information, one or more road features associated with an upcoming intersection. The method may also include determining, based on the one or more road features and a coding system, one or more navigation codes corresponding to the upcoming intersection. The method may also include determining, based on the one or more navigation codes, a prompt for navigation associated with the upcoming intersection.

According to a third aspect of the present disclosure, a non-transitory computer readable medium may store instructions, the instructions, when executed by at least one processor, the at least one processor may be configured to perform one or more of the following operations. The at least one processor may obtain a current location of a subject and navigation information. The at least one processor may determine, based on the current location and the navigation information, one or more road features associated with an upcoming intersection with respect to a current road segment. The at least one processor may determine, based on the one or more road features and a coding system, one or more navigation codes corresponding to the upcoming intersection. The at least one processor may determine, based on the one or more navigation codes, a prompt for navigation associated with the upcoming intersection.

According to a fourth aspect of the present disclosure, a system for navigation based on intersection coding is provided. The system may include an acquisition module configured to obtain a current location of a subject and navigation information. The system may also include a feature determination module configured to determine, based on the current location and the navigation information, one or more road features associated with an upcoming intersection with respect to a current road segment. The system may also include a navigation code determination module configured to determine, based on the one or more road features and a coding system, one or more navigation codes corresponding to the upcoming intersection. The system may further include a navigation prompt information determination module configured to determine based on the one or more navigation codes, a prompt for navigation associated with the upcoming intersection.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary navigation service system according to some embodiments of the present disclosure;

FIG. 2 is a schematic diagram illustrating hardware and/or software components of an exemplary computing device according to some embodiments of the present disclosure;

FIG. 3 is a schematic diagram illustrating hardware and/or software components of an exemplary mobile device according to some embodiments of the present disclosure;

FIG. 4 is a flowchart illustrating an exemplary process for navigation based on intersection coding according to some embodiments of the present disclosure;

FIG. 5 is a schematic diagram illustrating an exemplary eight-directional coordinate system according to some embodiments of the present disclosure;

FIG. 6 is a flowchart illustrating an exemplary process for determining road feature according to some embodiments of the present disclosure;

FIG. 7 is a flowchart illustrating an exemplary process for determining a prompt for navigation according to some embodiments of the present disclosure; and

FIG. 8 is a block diagram illustrating an exemplary processing device according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

It will be understood that the term “system,” “engine,” “unit,” “module,” and/or “block” used herein are one method to distinguish different components, elements, parts, section or assembly of different level in ascending order. However, the terms may be displaced by another expression if they may achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding a ground transportation system, it should be understood that this is only one exemplary embodiment. The systems and methods of the present disclosure may be applied to any other kind of transportation system. For example, the systems and methods of the present disclosure may be applied to transportation systems of different environments including ocean, aerospace, or the like, or any combination thereof. The vehicle of the transportation systems may include a car, a bus, a train, a subway, a vessel, an aircraft, a spaceship, a hot-air balloon, or the like, or any combination thereof.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

The present disclosure relates to systems and methods for navigation based on intersection coding. The system may obtain a current location of a subject and navigation information and determine one or more road features associated with an upcoming intersection based on the current location and the navigation information. The one or more road features may include at least one of one or more attributes of a road associated with the upcoming intersection, a location relationship between a target road segment that the subject travels to and a current road segment the subject locates, a count of one or more interference roads on the left of the target road segment, or a count of one or more interference roads on the right of the target road segment. The system may further determine one or more navigation codes corresponding to the upcoming intersection based on the one or more road features and a coding system. The coding system may provide a mapping relationship between a plurality of specific road features and a plurality of specific navigation codes, each of the plurality of specific navigation codes corresponds to a specific prompt for navigation, and the prompt for navigation may be selected from the specific prompts. The system may further determine a prompt for navigation associated with the upcoming intersection based on the one or more navigation codes.

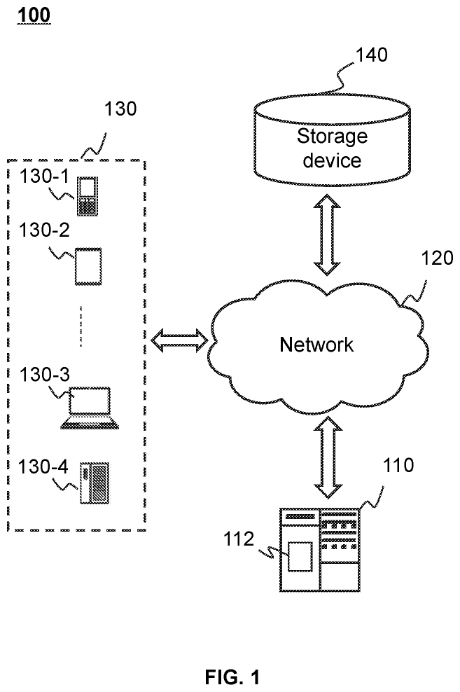

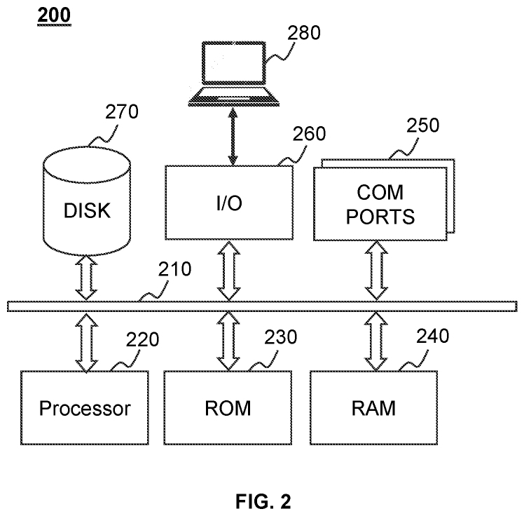

FIG. 1 is a schematic diagram illustrating an exemplary navigation service system 100 according to some embodiments of the present disclosure. The navigation service system 100 may include a server 110, a network 120, a client terminal 130, and a storage device 140. In some embodiments, the server 110 may determine a prompt for navigation associated with an upcoming intersection and sent the prompt to the client terminal 130 via the network 120. In some embodiments, the server 110 may be a single server or a server group. The server group may be centralized (e.g., a data center) or distributed (e.g., the server 110 may be a distributed system). In some embodiments, the server 110 may be local or remote. For example, the server 110 may access information and/or data stored in the client terminal 130 and/or the storage device 140 via the network 120. As another example, the server 110 may be directly connected to the client terminal 130 and/or the storage device 140 to access stored information and/or data. In some embodiments, the server 110 may obtain navigation information. The navigation information may be real-time navigation data and/or navigation data stored in the storage device 140. In some embodiments, the server 110 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2 in the present disclosure.

In some embodiments, the server 110 may include a processing device 112 (e.g., single-core processing engine(s) or multi-core processor(s)). The processing device 112 may process information and/or data related for navigation to perform one or more functions described in the present disclosure. For example, the processing device 112 may obtain a current location of a subject and navigation information via network 120. The processing device 112 may determine one or more road features associated with an upcoming intersection based on the current location of the subject and the navigation information. The processing device 112 may determine one or more navigation codes corresponding to the upcoming intersection based on the one or more road features and a coding system. The processing device 112 may determine a prompt for navigation associated with the upcoming intersection based on the one or more navigation codes. Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components (e.g., the server 110, the client terminal 130, or the storage device 140) of the navigation service system 100 may send information and/or data to other component(s) of the navigation service system 100 via the network 120. For example, the processing device 112 may obtain a current location of a subject and navigation information via network 120. The navigation information may at least include a navigation path. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points, through which one or more components of the navigation service system 100 may be connected to the network 120 to exchange data and/or information.

The client terminal 130 may be a device used by a subject for navigation. The client terminal 130 may be a smart device associated with a traveler. In some embodiments, the client terminal 130 may be configured to display and broadcast a prompt for navigation. In some embodiments, the client terminal 130 may send the real-time traffic information and/or location information to the server 110 or to the storage device 140 via the network 120. In some embodiments, the client terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smartwatch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift™, a HoloLens™, a Gear VR™, etc. In some embodiments, the built-in device in the vehicle 130-4 may include an onboard computer, an onboard television, etc. In some embodiments, the client terminal 130 may be a device with positioning technology (e.g., through a global positioning system (GPS) chipset) for locating the position of the user and/or the client terminal 130.

In some embodiments, the server 110 may transmit a connection request to the client terminal 130 and establish a connection with the client terminal 130 after the connection request is accepted by the client terminal 130. In some embodiments, the client terminal 130 may transmit a connection request to the server 110 and establish a connection with the server 110 after the connection request is accepted by the server 110. It should be noted that the communication between the server and the client terminal may refer to direct communication between them or communication between the applications installed on them.

The storage device 140 may store data and/or instructions. In some embodiments, the storage device 140 may store data obtained from the navigation service system 100, such as navigation information associated with the navigation service system 100, a coding system, etc. In some embodiments, the storage device 140 may store data and/or instructions that the server 110 may execute or use to perform exemplary methods described in the present disclosure. In some embodiments, storage device 140 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include random-access memory (RAM). Exemplary RAM may include a dynamic RAM (DRAM), a double data rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components of the navigation service system 100 (e.g., the server 110 or the client terminal 130). One or more components of the navigation service system 100 may access the data or instructions stored in the storage device 140 via the network 120. In some embodiments, the storage device 140 may be directly connected to or communicate with one or more components of the navigation service system 100 (e.g., the server 110 or the client terminal 130). In some embodiments, the storage device 140 may be part of the server 110. In some embodiments, the storage device 140 may be integrated in the client terminal 130.

In some embodiments, one or more components of the navigation service system 100 (e.g., the server 110 or the client terminal 130) may have permissions to access the storage device 140. In some embodiments, one or more components of the navigation service system 100 may read and/or modify information related to the user and/or the public when one or more conditions are met. For example, the server 110 may read and/or modify one or more users' information after a navigation service is completed.

FIG. 2 is a schematic diagram illustrating exemplary hardware and/or software components of a computing device 200 on which the server 110, the client terminal 130 and/or the processing device 112 may be implemented according to some embodiments of the present disclosure. For example, the processing device 112 may be implemented on the computing device 200 and configured to perform functions of the processing device 112 disclosed in this disclosure.

The computing device 200 may be a special purpose computer in some embodiments. The computing device 200 may be used to implement a navigation service system for the present disclosure. The computing device 200 may implement any component of the navigation service as described herein. In FIGS. 1-2, only one such computing device is shown purely for convenience purposes. One of ordinary skill in the art would understand that the computer functions relating to the navigation service as described herein may be implemented in a distributed fashion on a number of similar platforms, to distribute the processing load.

The computing device 200, for example, may include COM ports 250 connected to and from a network (e.g., the network 120) connected thereto to facilitate data communications. The computing device 200 may also include a processor 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components therein such as a user interface element 280. The computing device 200 may also receive programming and data via network communications.

Merely for illustration, only one processor 220 is described in the computing device 200. However, it should be note that the computing device 200 in the present disclosure may also include multiple processors, thus operations and/or method steps that are performed by one processor 220 as described in the present disclosure may also be jointly or separately performed by the multiple processors. For example, if in the present disclosure the processor 220 of the computing device 200 executes both operation A and operation B, it should be understood that operation A and operation B may also be performed by two different processors jointly or separately in the computing device 200 (e.g., the first processor executes operation A and the second processor executes operation B, or the first and second processors jointly execute operations A and B).

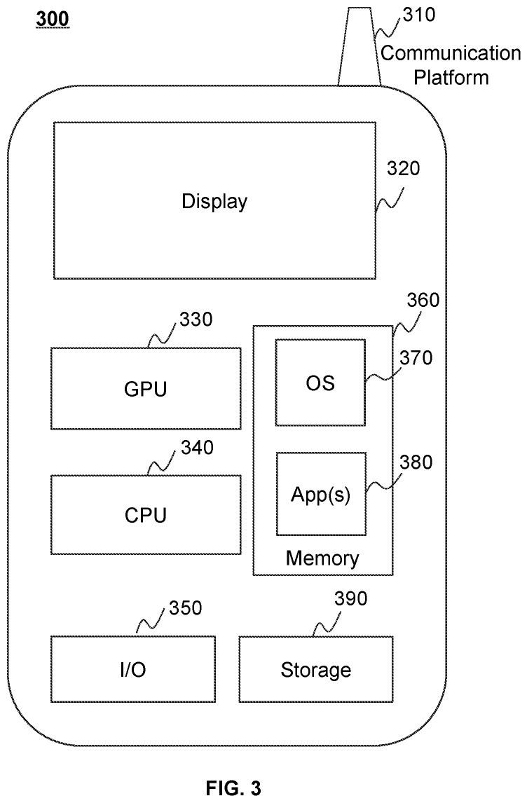

FIG. 3 is a schematic diagram exemplary hardware and/or software components of an exemplary mobile device 300 on which a client terminal may be implemented according to some embodiments of the present disclosure.

As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™′ Windows Phone™, etc.) and one or more applications 380 may be loaded into the memory 360 from the storage 390 in order to be executed by the CPU 340. The applications 380 may include a browser or any other suitable mobile apps for transmitting, receiving and presenting information relating to a navigation service or other information from the processing device 112 and/or the storage device 140. User interactions with the information stream may be achieved via the I/O 350 and provided to the processing device 112 and/or other components of the navigation service system 100 via the network 120. In some embodiments, the mobile device 300 may transmit (or receive) a connection request to the server 110 via a network 120 and establish a connection with the server 110 after the connection request is accepted by the server 110 (or the mobile device 300). After the connection between the server 110 and the mobile device 300 is established, the server 110 may communicate with the application(s) 380 installed on the mobile device 300 to transmit or receive information or data (e.g., user information, position information, navigation information, etc.). In some embodiments, the application(s) 380 may include a navigation service application (e.g., a taxi-hailing app, a map app, etc.).

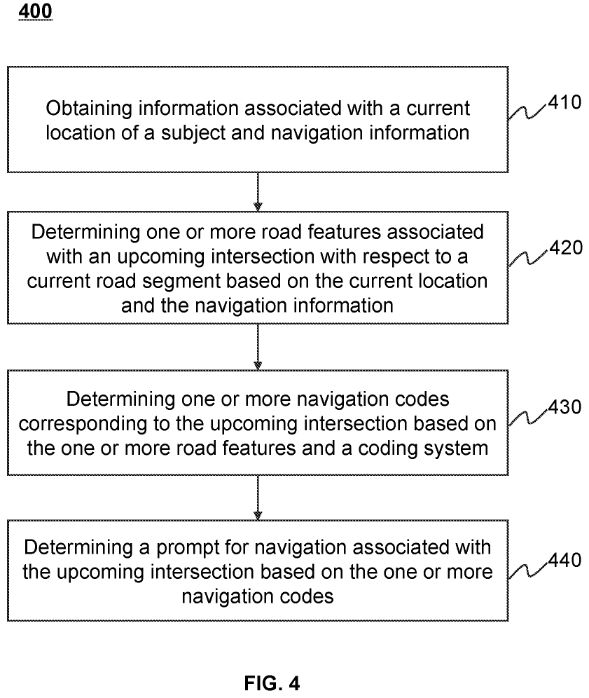

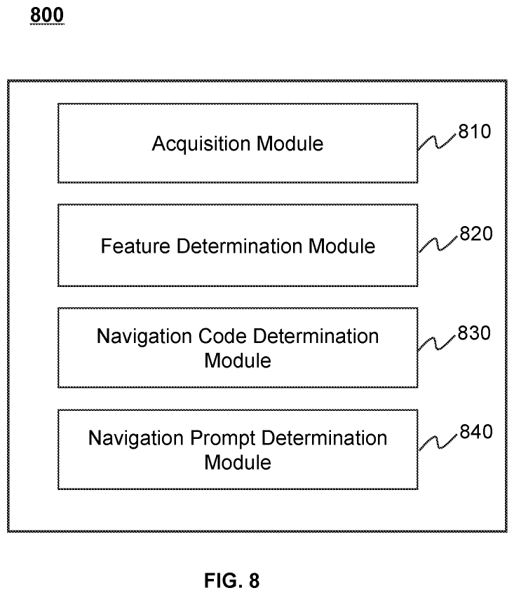

FIG. 4 is a flowchart illustrating an exemplary process for navigation base on intersection coding according to some embodiments of the present disclosure. In some embodiments, the process 400 may be implemented as a set of instructions (e.g., an application) stored in the storage device 140, ROM 230 or RAM 240, or storage 390. The processing device 112, the processor 220, the CPU 340 and/or the modules in FIG. 8 may execute the set of instructions, and when executing the instructions, the processing device 112, the processor 220, the CPU 340 and/or the modules in FIG. 8 may be configured to perform the process 400. The operations of the illustrated process presented below are intended to be illustrative. In some embodiments, the process 400 may be accomplished with one or more additional operations not described and/or without one or more of the operations discussed. Additionally, the order in which the operations of the process 400 illustrated in FIG. 4 and described below is not intended to be limiting.

In 410, the processing device 112 (e.g., the acquisition module 810) may obtain information associated with a current location of a subject and navigation information. The subject may include a person, a vehicle, an on-board device of the vehicle (e.g., a car, a bus, a motorbike, etc.), a mobile device, etc. In some embodiments, the information associated with the current location may include a geographic location of the subject, road information associated with the current location, or the like, or any combination thereof. In some embodiments, the geographic location of the subject may be denoted by longitude and latitude information. The geographic location of the subject may be obtained by a positioning device associated with the subject. The positioning device may include an on-board device of the vehicle, a positioning chip installed in a mobile terminal associated with the subject (e.g., the client terminal 130 or the mobile device 300 shown in FIG. 3).

The road information associated with the current location may include one or more attributes of a current road segment (or road) the subject locates or travels on when the subject at the current location. For example, the one or more attributes of the current road segment (or road) may include a name of the current road segment (or road), a number of lanes associated with the current road segment (or road), a velocity limit (e.g., a maximum velocity limit and/or a minimum velocity limit) associated with the current road segment (or road), a type of the current road segment (or road), a condition of the current road segment (or road), a length of the current road segment (or road), a starting point of the current road segment (or road), an ending point of the current road segment (or road), or the like, or a combination thereof.

The navigation information may include information and/or data associated with a navigation path from a departure location or the current location to a destination. The navigation path may present a travel route or trajectory for the subject travelling from the departure location or the current location to the destination. The travel route or trajectory may include a plurality of road segments (or roads). The information and/or data associated with the navigation path may include one or more attributes of each of the plurality of road segments on the navigation path, one or more attributes of other road segments connected or associated with each of the plurality of road segments on the navigation path, a position relationship between a road segment on the navigation path and other road segments connected with the road segment on the navigation path, a traffic condition on each of the plurality of road segments on the navigation path, etc. For example, the navigation information may include a name of each of the plurality of road segments, a number of lanes associated with the each of the plurality of road segments, a velocity limit (e.g., a maximum velocity limit and/or a minimum velocity limit) associated with the each of the plurality of road segments, a type of the each of the plurality of road segments, a condition of the each of the plurality of road segments, a length value of the each of the plurality of road segments, a starting point of the each of the plurality of road segments, an ending point of the each of the plurality of road segments, a number of intersections on each of the plurality of road segments, a number of traffic lights on each of the plurality of road segments, or the like, or a combination thereof. In some embodiments, the processing device 112 may obtain the navigation information from a server (e.g., the server 110 or another server for navigation), the client terminal 130, the storage device 140, etc. For example, a server for navigation may determine the navigation information based on the departure location and the destination. The server for navigation may transmit the navigation information to the client terminal 130, the storage device 140, or the server 110 (e.g., the processing device 112), directly. In some embodiments, the processing device 112 may determine the navigation information based on the current location or the departure location and the destination. In some embodiments, the navigation information may include the current location.

In 420, the processing device 112 (e.g., the feature determination module 820) may determine one or more road features associated with an upcoming intersection with respect to a current road segment based on the current location and the navigation information. As used herein, the upcoming intersection may refer to an intersection with respect to the current road segment when the subject travels along the navigation path from the departure location to the destination. In some embodiments, the one or more road features associated with the upcoming intersection may include one or more attributes of a road (or road segment) associated with the upcoming intersection, a location relationship between a target road segment that the subject travels to from the current road segment via crossing the upcoming intersection and the current road segment, a count of one or more interference roads on the left of the target road segment, a count of one or more interference roads on the right of the target road segment, or the like, or a combination thereof. As used herein, a specific road (or road segment) associated with the upcoming intersection may refer to a road segment where the subject may travel to by crossing the upcoming intersection. In some embodiments, a starting point or an ending point of the specific road (or road segment) associated with the upcoming intersection may be connected with the upcoming intersection. For example, the road (or road segment) associated with the upcoming intersection may include the current road segment, the target road segment, one or more interference road segments on the left and/or right of the current road segment and/or the target road segment, etc. The target road segment may be also referred to as a target exit road segment where the subject should travel to by crossing the upcoming intersection according to the navigation information (e.g., the navigation path).

In some embodiments, the one or more attributes of the road associated with the upcoming intersection may include one or more attributes of the current road segment and/or the target road segment as described elsewhere in the present disclosure. For example, the one or more attributes of the target road segment may include a type of the target road segment. The type of the target road segment may include a highway, an expressway, an expressway entrance/exit, a roundabout entrance/exit, a slope, an automatic driving roadway, etc. In some embodiments, a prompt for navigation may vary depending on the one or more road attributes. For example, if the target road segment is an expressway, the prompt for navigation may include a limiting-velocity of 120 kilometers per hour. If the target road segment is a highway, the prompt for navigation may include a limiting-velocity of 80 kilometers per hour.

As used herein, an interference road may refer to a candidate road segment the subject may travel to by using the upcoming intersection but is inconsistent with the navigation path from the departure location or the current location to the destination. In some embodiments, when there are one or more candidate road segments that are connected, adjacent and/or close to the target road segment, the one or more candidate road segments may disturb the subject's effort to travel to the target road segment when crossing the upcoming intersection. For example, when the subject needs to travel to a road segment in the left front while there are actually at least two road segments in the left front, the navigation cannot be performed accurately through a simple prompt such as “travel to the left front” or “turn left and take the left front road.” Accordingly, a prompt for navigation may be determined based on the count of one or more interference roads on the left of the target road segment and/or the count of one or more interference roads on the right of the target road segment. For example, when there are more than one interference roads, for example, the prompt for navigation may include “attention, there are a plurality of interference roads ahead, please travel cautiously.”

In some embodiments, the one or more road features may include lane information of the current road segment and/or the target road segment. For example, the lane information of the current road segment may include a number of lanes on the current road segment, a width of each of the lanes on the current road segment, etc. In some embodiments, the lane information may include a specific lane of the current road segment that the subject travels on. For example, when the current road segment has two or more lanes, the lane information may be that the subject locates on the left lane, or on the middle lane, or on the right lane. As another example, the lane information may be that the subject locates in the Nth lane (e.g., the first lane, the second lane, the third lane, etc.) from left to right or right to left. In some embodiments, the prompt for navigation may be varied based on the lane information. For example, if the subject is on the correct lane based on the lane information, the prompt for navigation may include reminding the subject to keep straight. As a further example, if the subject is on the incorrect lane based on the lane information, the prompt for navigation may include reminding the subject to change lanes.

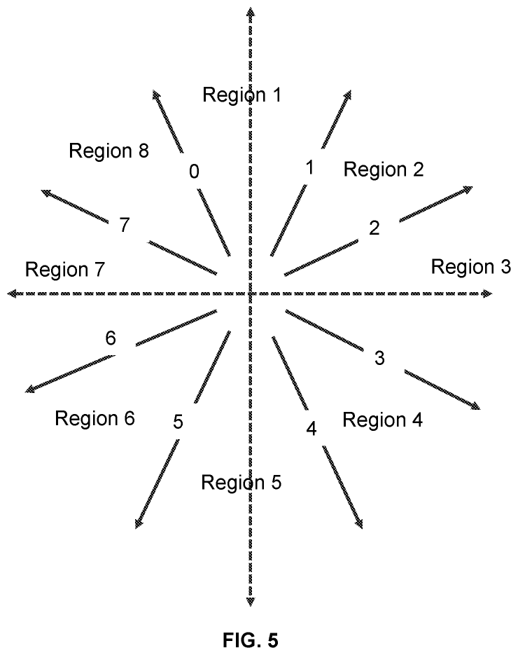

In some embodiments, the processing device 112 may determine the one or more road features (e.g., the location relationship between the target road segment and the current road segment) based on the current location and the navigation information using a multi-directional coordinate technique. Using the multi-directional coordinate technique, for the upcoming intersection, the processing device 112 may determine a multidirectional coordinate system based on the current road segment and the upcoming intersection. The upcoming intersection may be designated as a center of the multidirectional coordinate system. The multidirectional coordinate system may include a plurality of directions. For example, the multidirectional coordinate system may be a six-directional coordinate system including six directions, an eight-directional coordinate system including eight directions, a twelve-directional coordinate system including twelve directions, etc. The plurality of directions may be designated with a serial number, such as 1, 2, 3, etc., or A, B, C, etc., from a base direction clockwise or anti-clockwise. In some embodiments, the base direction may be an entry direction of the current road segment. In some embodiments, the base direction may be one direction of the plurality of directions. The angle between two adjacent directions of plurality of directions may be same (e.g., 60 degrees, 45 degrees, 30 degrees, etc.). The plurality of directions may divide the multidirectional coordinate system into a plurality of regions. The count of the plurality of regions may be the same as the count of the plurality of directions. The plurality of regions may be designated with a serial number, such as 1, 2, 3, etc., or A, B, C, etc., from the base direction clockwise or anti-clockwise. More descriptions of the multidirectional coordinate system may be found in FIG. 5.

In some embodiments, the processing device 112 may define and/or describe the location relationship between the target road segment and the current road segment based on a target region that the target road segment belongs to in the multidirectional coordinate system. For example, the processing device 112 may determine that the target road segment belongs to “region 1” in the multidirectional coordinate system. The target region may be “region 1.” The processing device 112 may describe the location relationship between the target road segment and the current road segment using “region 1.” The processing device 112 may determine the target region by mapping the navigation path in the navigation information to the multidirectional coordinate system based on the current road segment.

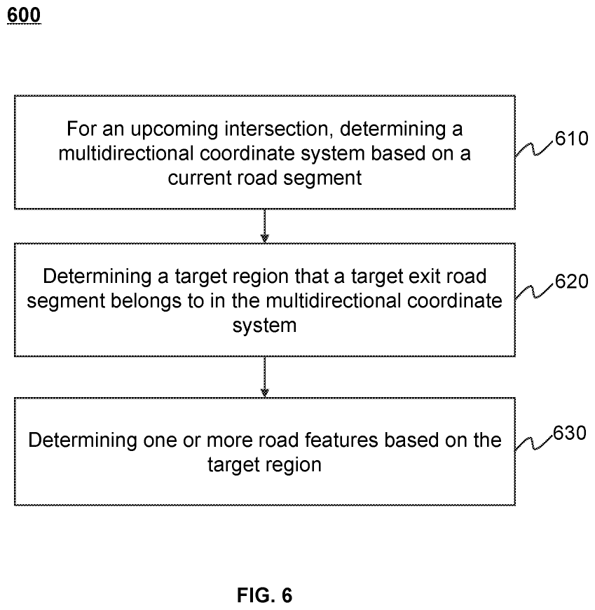

In some embodiments, the processing device 112 may determine other road features based on the target region. For example, the processing device 112 may determine a count of one or more candidate road segments that the subject can travel to on either side of the target road segment, respectively, as the count of interference roads on the left of the target road segment and the count of interference roads on the right of the target road segment. In some embodiments, the one or more candidate road segments may belong to the target region. For example, as shown in FIG. 5, when the target road segment belongs to region 2, the count of one or more interference roads on the left of the target road segment may be the count of one or more road segments that the subject can travel to on the left of the target road segment in region 2. The count of one or more interference roads on the right of the target road segment may be the count of one or more road segments that the subject can travel to on the right of the target road segment in region 2. In some embodiments, the one or more candidate road segments may belong to the target region and one or more adjacent regions of the target region. For example, example, when the target road segment belongs to region 2, the count of one or more interference roads on the left of the target road segment may be the count of one or more road segments that the subject can travel to on the left of the target road segment in region 1 and region 2. The count of one or more interference roads on the right of the target road segment may be the count of one or more road segments that the subject can travel to on the right of the target road segment in region 2 and region 3. More descriptions for determining the one or more road features may be found in FIG. 6 and the descriptions thereof.

In 430, the processing device 112 (e.g., the navigation code determination module 830) may determine a navigation code corresponding to the upcoming intersection based on the one or more road features and a coding system. The navigation code may correspond to a prompt for navigation associated with the upcoming intersection. The prompt for navigation associated with the upcoming intersection may be used to guide the subject (e.g., a driver, a vehicle, a pedestrian, etc.) to cross the upcoming intersection and travel to the target road segment.

The coding system may provide a mapping relationship between a plurality of groups of specific road features and a plurality of specific navigation codes. Each group of the plurality of groups of specific road features may include one or more specific road features. Each group of the plurality of groups of specific road features may correspond to one of the plurality of specific navigation codes. Each of the plurality of specific navigation codes may corresponds to a specific prompt for navigation, and the prompt for navigation may be selected from the specific prompts.

In some embodiments, the processing device 112 may determine the navigation code corresponding to the one or more road features associated with the upcoming intersection based on the mapping relationship. In some embodiments, the coding system may be denoted as a model that provides the mapping relationship between the plurality of groups of specific road features and the plurality of specific navigation codes. The processing device 112 may input the one or more road features associated with the upcoming intersection into the model. The model may generate the navigation code corresponding to the one or more road features associated with the upcoming intersection based on the mapping relationship. In some embodiments, the model may be obtained from the client terminal 130, the storage device 140, or any other server different from the server 110. In some embodiments, the model may be obtained by training a machine learning model using a training set. The training set may include a plurality of groups of training data. Each group of the plurality of training data may include one or more road features associated with an intersection and a prompt for navigation corresponding to the intersection denoted by a navigation code. Exemplary machine learning models may include a convolutional machine learning model (CNN), a fully convolutional neural network (FCN) model, a generative adversarial network (GAN), a back propagation (BP) machine learning model, a radial basis function (RBF) machine learning model, a deep belief nets (DBN) machine learning model, an Elman machine learning model, or the like, or a combination thereof.

In some embodiments, the processing device 112 may compare the one or more road features determined in operation 420 with each group of the plurality of groups of specific road features to determine a target group of the plurality of groups of specific features consistent with the one or more road features determined in operation 420. The processing device 112 may designate the specific navigation code corresponding to the target group of the plurality of groups of specific features as the navigation code corresponding to the upcoming intersection. For example, the coding system may be denoted as a table (e.g., Table 1) stored in a database. The table may provide the plurality of groups of specific road features, the plurality of specific navigation codes, and the mapping relationship between the plurality of groups of specific road features and the plurality of specific navigation codes. The processing device 112 may access the database and retrieve the navigation code corresponding to the one or more road features associated with the upcoming intersection based on the one or more road features from the table.

As shown in Table 1, Table 1 includes a plurality of groups of road features, such as a road attribute, a location relationship between a target road segment and a current road segment (denoted by region), a count of one or more interference roads on the left of the target road segment, a count of one or more interference roads on the right of the target road segment, a lane information, etc. Table 1 may also include a plurality of navigation codes corresponding to the plurality of groups of road features. The one or more navigation codes may be labeled as numbers such as 1, 2, 3, 4, 5, 6, etc. In some embodiments, the one or more navigation codes may also be labeled as other symbols, such as A1, A2, A3, A4, A5, A6, etc. Different groups of road features may correspond to different navigation codes.

TABLE 1
Comparison table of road features and navigation codes

| | | | Count of | Count of | |
|---|---|---|---|---|---|
| | | | interference | interference | Navigation |
| Region | Location | Road attribute | roads (left) | roads (right) | code |
| 0 | Middle | other | 0 | 0 | 1 |
| 5, 6, 7 | Left | other | 0 | 0 | 2 |
| 1, 2, 3 | Right | other | 0 | 0 | 3 |
| 4 | Left | other | 0 | 0 | 4 |
| 0 | Middle | highway, | 1 | 1 | 5 |
| | | expressway | | | |
| 0 | Left | expressway | 0 | 1 | 6 |
| | | entrance/exit, | | | |
| | | roadway, other | | | |
| 0 | Left | slope, other | 0 | 1 | 7 |
| 0 | Left | expressway | 0 | 2 | 8 |
| | | entrance/exit, | | | |
| | | roadway, other | | | |
| 0 | Left | expressway | 0 | 2 | 9 |
| | | entrance/exit, | | | |
| | | roadway, other | | | |
| 0 | Left | expressway | 1 | 1 | 10 |
| | | entrance/exit, | | | |
| | | roadway, other | | | |
| 0 | Middle | expressway | 1 | 0 | 11 |
| | | entrance/exit, | | | |
| | | roadway, other | | | |
| 0 | Right | expressway | 1 | 0 | 12 |
| | | entrance/exit, | | | |
| | | roadway, other | | | |
| 0 | Right | expressway | 2 | 0 | 13 |
| | | entrance/exit, | | | |
| | | roadway, other | | | |
| 0 | Right | expressway | 2 | 0 | 14 |
| | | entrance/exit, | | | |
| | | roadway, other | | | |
| 0 | Right | expressway | 1 | 1 | 15 |
| | | entrance/exit, | | | |
| | | roadway, other | | | |
| 0 | Middle | expressway | 0 | 1 | 16 |
| | | entrance/exit, | | | |
| | | roadway, other | | | |
| 0 | Middle | expressway | 1 | 0 | 17 |
| | | entrance/exit, | | | |
| | | roadway, other | | | |
| 5, 6, 7 | Left | other | 0 | 1 | 18 |
| 5, 6, 7 | Left | other | 1 | 0 | 19 |
| 1, 2, 3 | Right | other | 0 | 1 | 20 |
| 1, 2, 3 | Right | other | 1 | 0 | 21 |

In Table 1, “Region” may refer to the target region that the target road segment belongs to in the multidirectional coordinate system (e.g., eight-directional coordinate system). “Location” may refer to the location of the subject on the current road segment, for example, on the left, on the right, or in the middle of the current road segment. Specifically, when the current road segment that the subject travels on has two or more lanes, “Location” may refer to the lane information as related to the subject. The lane information may be that the subject is traveling on the left lane, or on the middle lane, or on the right lane, or on the Nth lane. “Road attribute” may refer to one or more attributes of the current road segment and/or the target road segment. For example, the one or more attributes may include a highway, an expressway, an expressway entrance/exit, a slope, an automatic driving roadway, and other attributes. “Count of interference roads (left)” and “Count of interference roads (right)” may refer to the count of interference roads on the left of the target road segment and the count of interference roads on the right of the target road segment, respectively. “Navigation code” may refer to a code in the coding system. Different navigation codes may correspond to different prompts for navigation.

The table for the coding system may be set by a user or according to a default setting of the navigation service system 100. For example, a plurality of samples (i.e., historical travel data) may be collected and/or acquired. Each of the plurality of samples may include one or more road features associated with an intersection and a prompt for navigation corresponding to the intersection. The plurality of group of specific road features may be determined based on combinations of the one or more road features in each of the plurality of samples. For example, a road attribute and a location relationship between a target road segment and a current road segment may be a combination. A specific navigation prompt corresponding to each group of the plurality of groups of specific road features may be determined. Then each group of the plurality of groups of specific road features and the corresponding specific navigation prompt may form the coding system.

The coding system may be updated from time to time, e.g., periodically or whenever enough data is available, based on samples (or a training set) that are at least partially different from the original samples (or a training set) from which the coding system is determined. For instance, the coding system may be updated based on samples (or a training set) that are different from the original samples (or training set). In some embodiments, the determination and/or updating of the coding system may be performed on a processing device, while the application of the coding system may be performed on a different processing device. In some embodiments, the determination and/or updating of the coding system may be performed on a processing device of a system different than the navigation service system 100 on which the application of the coding system is performed. For instance, the determination and/or updating of the coding system may be performed on a first system of a vendor who provides and/or maintains such a coding system and/or has access to samples (or training set) used to determine and/or update the coding system, while the application of the provided coding system, may be performed on a second system of a client of the vendor. In some embodiments, the determination and/or updating of the coding system may be performed online in response to a request for navigation. In some embodiments, the determination and/or updating of the coding system may be performed offline.

In some embodiments, a user (e.g. a subject or a client) may choose to update and/or switch the coding system based on the user's preferences or after the user decides that a specific coding system is best for him/her best on the user's analysis. For example, the user may ask to update the coding system by verbal (e.g. voice) request; the processing device 112 may receive such a request and start an update. As another example, the user may choose from several coding systems that have been preset by the processing device 112. For instance, the user may choose from a “safest” coding system (e.g., a system that places safety as the highest priority, sometimes at the expense of other concerns), a “fastest” coding system (e.g., a system that aims to help the subject to reach the destination in the shortest time period), and a “most interesting” coding system (e.g., a system that aims to introduce the most points of interest). It should be noted that, in certain embodiments, the different preset coding systems are associated with the same path; the specific prompts only help to achieve the intended goals by different presentations (e.g., the specific prompts for the “most interesting” coding system can include introductions to points of interests around the target intersection). In certain embodiments, however, the different preset coding systems are associated with different paths, and determination of the path helps to achieve the intended goals.

In 440, the processing device 112 (e.g., the navigation prompt determination module 840) may determine a prompt for navigation associated with the upcoming intersection based on the navigation code. In some embodiments, the prompt for navigation may include a voice, a text, an image, or the like, or any combination thereof. For example, the prompt for navigation may include a voice “turn right,” and an image with an arrow pointing right. In some embodiments, the prompt for navigation may include the road information associated with the current location (e.g., one or more attributes associated with the current road segment), the one or more road features associated with the upcoming intersection, etc. For example, the prompt for navigation may include the limiting-velocity of the current road segment, the correction lane that the subject should travel on, a distance from the current location to the upcoming intersection, etc. As another example, the prompt for navigation may include the name of the target road segment, the limiting-velocity of the target road segment, a travel direction for crossing the upcoming intersection, etc. In some embodiments, the processing device 112 may send the prompt for navigation to the client terminal 130, and direct the client terminal 130 to display the prompt for navigation.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, a broadcast operation may be integrated into operation 440. As another example, one or more other optional operations (e.g., a storing operation) may be added elsewhere in the process 400. In the storing operation, the processing device 112 may store information and/or data (e.g., the current location of the subject, the navigation information, the one or more road features, etc.) associated with the prompt for navigation determining in a storage device (e.g., the storage device 140) disclosed elsewhere in the present disclosure. In some embodiments, operation 420 and operation 430 may be integrated into one operation. For example, the coding system may be denoted as a model. The model may provide a mapping relationship between road features and navigation codes. The model may be further configured to provide a mapping relationship between navigation nodes and prompts for navigations. Using the model, the prompt for navigation may be generated by inputting the one or more road features obtained in operation 420 into the model. The prompt for navigation may be outputted by the model based on the mapping relationships.

FIG. 5 is a schematic diagram illustrating an exemplary eight-directional coordinate system according to some embodiments of the present disclosure. As shown in FIG. 5, the eight-directional coordinate system may have four reference directions. The four reference directions may take the current forward direction of the subject as a straight front direction, and take the opposite direction of the straight front direction as a straight behind direction. As used herein, the current forward direction of the subject may be also referred to as an entry direction of a current road segment that the subject travels on. The four reference directions may also include a left and a right direction perpendicular to the straight front direction.

The eight-directional coordinate system may take the center point of an upcoming intersection with respect to a current location of a subject as a coordinate origin. The eight-directional coordinate system may include eight directions determined based on the four reference directions. The eight directions may be numbered as direction 0-7. For example, with the current forward direction of the subject (i.e., straight front direction) as a base direction, direction 0 deviates 22.5° from the left of the base direction or deviates 337.5° from the base direction clockwise. Direction 1 deviates 22.5° from the right of the reference direction or deviates 22.5° from the base direction clockwise. Direction 2 deviates 67.5° from the right of the reference direction or deviates 67.5° from the base direction clockwise. Direction 3 deviates 112.5° from the right of the reference direction or deviates 112.5° from the base direction clockwise. Direction 4 deviates 157.5° from the right of the reference direction or deviates 157.5° from the base direction clockwise. Direction 5 deviates 157.5° from the left of the reference direction or deviates 202.5° from the base direction clockwise. Direction 6 deviates 112.5° from the left of the reference direction or deviates 247.5° from the base direction clockwise. Direction 7 deviates 67.5° from the left of the reference direction or deviates 292.5° from the base direction clockwise. The eight-directional coordinate system includes eight regions divided by the eight directions. The eight regions may be numbered as region 0-7. For example, region 0 is between the direction 0 and the direction 1 (including the direction 0). Region 1 is between the direction 1 and the direction 2 (including the direction 1). Region 2 is between the direction 2 and the direction 3 (including the direction 2). Region 3 is between the direction 3 and the direction 4 (including the direction 3). Region 4 is between the direction 4 and the direction 5 (including the direction 4). Region 5 is between the direction 5 and the direction 6 (including the direction 5). Region 6 is between the direction 6 and the direction 7 (including the direction 6). Region 7 is between the direction 7 and the direction 0 (including the direction 7).

FIG. 6 is a schematic flowchart illustrating an exemplary process for determining one or more road features according to some embodiments of the present disclosure. In some embodiments, the process 600 may be implemented as a set of instructions (e.g., an application) stored in the storage device 140, ROM 230 or RAM 240, or storage 390. The processing device 112, the processor 220, the CPU 340 and/or the road feature determination module in FIG. 8 may execute the set of instructions, and when executing the instructions, the processing device 112, the processor 220, the CPU 340 and/or the road feature determination module in FIG. 8 may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process 600 illustrated in FIG. 6 and described below is not intended to be limiting.

In 610, for an upcoming intersection, the processing device 112 may determine a multidirectional coordinate system based on a current road segment. In some embodiments, the processing device 112 may determine the current road segment based on a current location. For example, the current road segment may be determined by mapping the current location with a road network that includes a plurality of roads or road segments and a topotaxy between the plurality of roads or road segments.

In some embodiments, the multidirectional coordinate system may be a six-directional coordinate system, an eight-directional coordinate system, a twelve-directional coordinate system, etc. In some embodiments, the processing device 112 may determine an upcoming intersection based on navigation information and the current location as described elsewhere in the present disclosure (e.g., FIG. 4 and the descriptions thereof. The processing device 112 may take the upcoming intersection as a coordinate origin of the multidirectional coordinate system. The processing device 112 may take an entry direction of the current road segment as a base direction. The processing device 112 may determine a plurality of directions (e.g., six directions, eight directions, twelve directions, etc.) of the multidirectional coordinate system based on the base direction. For example, for a twelve-directional coordinate system, the processing device 112 may take the base direction as one of the twelve directions. Then the processing device 112 may determine other eleven directions by respectively deviating a specific degree including 30 degrees, 60 degrees, 90 degrees, 120 degrees, 150 degrees, 180 degrees, 210 degrees, 240 degrees, 270 degrees, 300 degrees, 330 degrees, from the base direction anti-clockwise or clockwise. In some embodiments, the multidirectional coordinate system may include a plurality of regions divided by the plurality of direction. More descriptions for the multidirectional coordinate system may be found elsewhere in the present disclosure (e.g., FIGS. 4-5 and the descriptions thereof).

In 620, the processing device 112 may determine a target region that a target exit road segment belongs to in the multidirectional coordinate system. The target exit road segment may refer to a road segment that the subject should travels to by crossing the upcoming intersection along the navigation path. In some embodiments, the processing device 112 may determine the target region by mapping the navigation path in the navigation information to the multidirectional coordinate system based on the current road segment. For example, the navigation path may include the current road segment and the target road segment. The current road segment and the target road segment may be connected with the upcoming intersection. The processing device 112 may take the entry direction of the current road segment as the base direction of the multidirectional coordinate system. Then the processing device 112 may project the navigation path along the base direction on the multidirectional coordinate system. The current road segment may be projected on the base direction of the multidirectional coordinate system. The target road segment may be projected on the multidirectional coordinate system and belong to a specific region of the plurality of regions of the multidirectional coordinate system. The specific region of the multidirectional coordinate system may be also referred to as the target region.

In 630, the processing device 112 may determine one or more road features based on the target region. In some embodiments, the one or more road features may include a location relationship between the target road segment and the current road segment, a count of one or more interference roads on the left of the target road segment, or a count of one or more interference roads on the right of the target road segment, or the like, or any combination thereof.

In some embodiments, the location relationship between the target road segment and the current road segment may be denoted by the target region. As shown in FIG. 5, if the target road segment belongs to region 2, the processing device 112 may use region 2 to represent the location relationship between the target road segment and the current road segment. In some embodiments, the location relationship between the target road segment and the current road segment may be denoted by two directions associated with the target region. For example, region 2 may be formed by direction 1 and direction 2. Assuming that the target road segment belongs to region 2, the processing device 112 may use direction 1 and direction 2 to denote the location relationship between the target road segment and the current road segment. In some embodiments, the location relationship between the target road segment and the current road segment may be denoted by an angle between the base direction and a direction associated with the target region. For example, region 2 may be formed by direction 1 and direction 2. Assuming that the target road segment belongs to region 2, the processing device 112 may use an angle between the base direction and direction 1 and/or direction 2 to denote the location relationship between the target road segment and the current road segment.

In some embodiments, the processing device 112 may determine a count of one or more road segments that the subject can travel to on either of two sides of the target road segment, respectively, as the count of interference roads on the left of the target road segment and the count of interference roads on the right of the target road segment in the target region. For example, as shown in FIG. 5, when the target road segment belongs to region 2, the count of one or more interference roads on the left of the target road segment may be the count of one or more road segments in region 2 that the subject can travel to on the left of the target road segment. The count of one or more interference roads on the right of the target road segment may be the count of one or more road segments in region 2 that the subject can travel to on the right of the target road segment. In some embodiments, the processing device 112 may also determine a count of one or more road segments that the subject can travel to on either of two sides of the target road segment, respectively, as the count of interference roads on the left of the target road segment and the count of interference roads on the right of the target road segment in the target region and an adjacent region of the target region. For example, as shown in FIG. 5, when the target road segment belongs to region 2, the count of one or more interference roads on the left of the target road segment may be the count of one or more road segments that the subject can travel to on the left of the target road segment in region 1 and region 2. The count of one or more interference roads on the right of the target road segment may be the count of one or more road segments that the subject can travel to on the right of the target road segment in region 2 and region 3.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, in 610, the processing device 112 may also obtain a current location of a subject. As another example, one or more other optional operations (e.g., a storing operation) may be added elsewhere in the process 600. In the storing operation, the processing device 112 may store information and/or data (e.g., the multidirectional coordinate system, the target region, the one or more road features, etc.) associated with the prompt for navigation determining in a storage device (e.g., the storage device 140) disclosed elsewhere in the present disclosure.

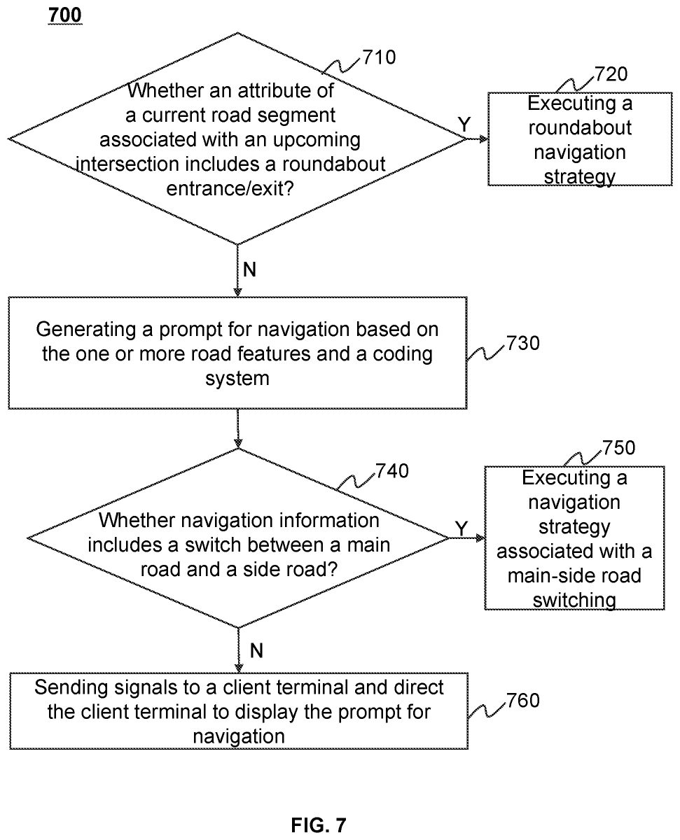

FIG. 7 is a schematic flowchart illustrating an exemplary process for a navigation strategy according to some embodiments of the present disclosure. In some embodiments, the processing device 112 may determine whether to execute the navigation process 400 described in FIG. 4 in the present disclosure based on one or more road attributes. In some embodiments, when the road attribute of the current road segment belongs to other attributes, for example, the user is located on a roundabout, the processing device 112 may not execute the navigation process 400 described in FIG. 4 but executing a corresponding roundabout navigation strategy. In some embodiments, the process 700 may be implemented as a set of instructions (e.g., an application) stored in the storage device 140, ROM 230 or RAM 240, or storage 390. The processing device 112, the processor 220 and/or the CPU 340 may execute the set of instructions, and when executing the instructions, the processing device 112, the processor 220 and/or the CPU 340 may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process 700 illustrated in FIG. 7 and described below is not intended to be limiting.

In 710, the processing device 112 may determine whether an attribute of a current road segment associated with an upcoming intersection includes a roundabout entrance/exit. In response to a determination that the attribute of the current road segment associated with the upcoming intersection includes a roundabout entrance/exit, the processing device 112 may proceed to perform operation 720. In response to a determination that the attribute of the current road segment associated with the upcoming intersection does not include a roundabout entrance/exit, the processing device 112 may proceed to perform operation 730. More descriptions for the attribute of the current road segment may be found elsewhere in the present disclosure (e.g., FIG. 4 and the descriptions thereof).

In 720, the processing device 112 may execute a roundabout navigation strategy. A roundabout may be a type of intersection in which road traffic is permitted to flow in one direction (e.g., anti-clockwise or clockwise) around a center (e.g., an island). A roundabout may be denoted as a closed loop connecting with at least two road segments. Using the roundabout navigation strategy, the processing device 112 may generate a prompt for navigation based on serial numbers of the at least two road segments connected with the roundabout. In some embodiments, when a vehicle needs to cross a roundabout, a current road segment that the vehicle travels on to enter the roundabout may be designated as an enter road. Other roads connected with the roundabout excluding the enter road may be designated as an exit road. Using the roundabout navigation strategy, the processing device 112 may number the at least two road segments connected with the roundabout from the enter road anti-clockwise or clockwise. For example, the processing device 112 may determine the current road segment for entering the roundabout as the NO. 1 road segment, and sequentially determine other road segments connected with the roundabout as the NO. 2 road segment, the NO. 3 road segment, the NO. 4 road segment, etc., from the enter road anti-clockwise or clockwise. The processing device 112 may determine a target exit road segment based on navigation information. Then the processing device 112 may determine the serial number of the target exit road segment and determine a prompt for navigation based on the serial number of the target exit road segment. For example, if the target exit road segment is NO. 2 road segment, the processing device 112 may determine a prompt for navigation including “please travel out of the roundabout from the NO. 2 road segment.” The prompt for navigation may be a voice prompt, an image prompt, etc.

In 730, the processing device 112 may generate a prompt for navigation base on the one or more road features and a coding system. For example, the processing device 112 may obtain the current location of the subject and navigation information. The processing device 112 may determine one or more road features associated with the upcoming intersection with respect to a current road segment based on the current location and the navigation information. The processing device 112 may further determine one or more navigation codes corresponding to the upcoming intersection based on the one or more road features and a coding system, and determine a prompt for navigation associated with the upcoming intersection based on the one or more navigation codes. The coding system may provide a mapping relationship between a plurality of specific road features and a plurality of specific navigation codes. Each of the plurality of specific navigation codes may corresponding to a specific prompt for navigation. The prompt for navigation may be determined from the specific navigation prompts for navigation. Detailed description regarding the determination of the prompt for navigation may be disclosed elsewhere in the present disclosure, for example, FIG. 4 and the description thereof.

In 740, the processing device 112 may determine whether navigation information includes a switch between a main road and a side road. In response to a determination that the navigation information includes the switch between the main road and the side road, the processing device 112 may proceed to perform operation 750. In response to a determination that the navigation information does not include the switch between the main road and the side road, the processing device 112 may proceed to perform operation 760. As used herein, the side road may refer to an auxiliary road that relieves congestion along the main road by routing traffic on one or both sides of the main road. In some embodiments, when a vehicle needs to cross the upcoming intersection according to a navigation path, the vehicle may need to travel from the main road to the side road for crossing the upcoming intersection.

In 750, the processing device 112 may execute a navigation strategy associated with a main-side road switching. Using the navigation strategy associated with the main-side road switching, the processing device 112 may add information associated with the main-side road switching into the prompt for navigation generated in operation 730. For example, when the subject needs to turn right while there are one or more interference roads on the left and/or on the right of the target road segment, and the subject needs to switch from the main road to the side road, the processing device 112 may generate a voice prompt for navigation including “switching from the main road to the side road, turn right and take the middle lane.” In some embodiments, the processing device 112 may generate an image prompt for navigation for distinguishing the main road and side road, for example, with different colors.

In 760, the processing device 112 may send signals to a client terminal and direct the client terminal to display the prompt for navigation. In some embodiments, the prompt for navigation may include a voice, a text, an image, or any combination thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, in 710, the processing device 112 may also obtain a current location of a subject. As another example, one or more other optional operations (e.g., a storing operation) may be added elsewhere in the process 700. In the storing operation, the processing device 112 may store information and/or data (e.g., the one or more attributes, the current road segment, the roundabout navigation strategy, etc.) associated with the prompt for navigation determining in a storage device (e.g., storage device 140) disclosed elsewhere in the present disclosure.

FIG. 8 is a block diagram illustrating an exemplary processing device 112 according to some embodiments of the present disclosure. The processing device 112 may include an acquisition module 810, a feature determination module 820, a navigation code determination module 830, and a navigation prompt determination module 840. Each of the modules described above may be a hardware circuit that is designed to perform certain actions, e.g., according to a set of instructions stored in one or more storage media, and/or any combination of the hardware circuit and the one or more storage media.

The acquisition module 810 may be configured to obtain information associated with a current location of a subject and navigation information. The subject may include a person, a vehicle, an on-board device of the vehicle (e.g., a car, a bus, a motorbike), a mobile device, etc. In some embodiments, the information associated with the current location may include a geographic location of the subject, road information associated with the current location, or the like, or any combination thereof. In some embodiments, the geographic location of the subject may be denoted by longitude and latitude information. The road information associated with the current location may include one or more attributes of a current road segment (or road) the subject locates or travels on when the subject at the current location. For example, the one or more attributes of the current road segment (or road) may include a name of the current road segment (or road), a number of lanes associated with the current road segment (or road), a velocity limit (e.g., a maximum velocity limit and/or a minimum velocity limit) associated with the current road segment (or road), a type of the current road segment (or road), a condition of the current road segment (or road), a length of the current road segment (or road), a starting point of the current road segment (or road), an ending point of the current road segment (or road), or the like, or a combination thereof. The navigation information may include information and/or data associated with a navigation path from a departure location or the current location to a destination.

The feature determination module 820 may be configured to determine one or more road features associated with an upcoming intersection based on the current location and the navigation information. In some embodiments, the one or more road features associated with the upcoming intersection may include one or more attributes of a road (or road segment) associated with the upcoming intersection, a location relationship between a target road segment that the subject travels to from the current road segment via crossing the upcoming intersection, a count of one or more interference roads on the left of the target road segment, a count of one or more interference roads on the right of the target road segment, or the like, or a combination thereof.

In some embodiments, the feature determination module 820 may determine the one or more road features (e.g., the location relationship between the target road segment and the current road segment) based on the current location and the navigation information using a multi-directional coordinate technique. Using the multi-directional coordinate technique, for the upcoming intersection, the feature determination module 820 may determine a multidirectional coordinate system based on the current road segment and the upcoming intersection. In some embodiments, the feature determination module 820 may define and/or describe the location relationship between the target road segment and the current road segment based on a target region that the target road segment belongs to in the multidirectional coordinate system. In some embodiments, the feature determination module 820 may determine other road features based on the target region. For example, the feature determination module 820 may determine a count of one or more candidate road segments that the subject can travel to on either of two sides of the target road segment, respectively, as the count of interference roads on the left of the target road segment and the count of interference roads on the right of the target road segment.

The navigation code determination module 830 may be configured to determine one or more navigation codes corresponding to the upcoming intersection based on the one or more road features and a coding system. The coding system may provide a mapping relationship between a plurality of groups of specific road features and a plurality of specific navigation codes. Each group of the plurality of groups of specific road features may include one or more specific road features. Each group of the plurality of groups of specific road features may correspond to one of the plurality of specific navigation codes. Each of the plurality of specific navigation codes may correspond to a specific prompt for navigation, and the prompt for navigation may be selected from the specific prompts.

In some embodiments, the navigation code determination module 830 may determine the navigation code corresponding to the one or more road features associated with the upcoming intersection based on the mapping relationship. In some embodiments, the coding system may be denoted as a model that provides the mapping relationship between the plurality of groups of specific road features and the plurality of specific navigation codes. The model may be implemented on a processor (e.g., the processor 220 as illustrated in FIG. 2). The navigation code determination module 830 may input the one or more road features associated with the upcoming intersection into the model. The model may generate the navigation code corresponding to the one or more road features associated with the upcoming intersection based on the mapping relationship.

The navigation prompt determination module 840 may be configured to determine a prompt for navigation associated with the upcoming intersection based on the one or more navigation codes. In some embodiments, the prompt for navigation may include a voice, a text, an image, or the like, or any combination thereof. For example, the prompt for navigation may include a voice “turn right,” and an image with an arrow pointing right. In some embodiments, the prompt for navigation may include the road information associated with the current location (e.g., one or more attributes associated with the current road segment), the one or more road features associated with the upcoming intersection, etc. For example, the prompt for navigation may include the limiting-velocity of the current road segment, the correction lane that the subject should travel on, a distance from the current location to the upcoming intersection, etc. As another example, the prompt for navigation may include the name of the target road segment, the limiting-velocity of the target road segment, a travel direction for crossing the upcoming intersection, etc. In some embodiments, the navigation prompt determination module 840 may send the prompt for navigation to the client terminal 130, and direct the client terminal 130 to display the prompt for navigation.

It should be noted that the above description is merely provided for the purposes of illustration, and not intended to limit the scope of the present disclosure. Apparently, for persons having ordinary skills in the art, multiple variations and modifications may be conducted under the teachings of the present disclosure. However, those variations and modifications do not depart from the scope of the present disclosure. For example, the processing device 112 may further include a display module (not shown in FIG. 8). The display module may be configured to direct a client terminal to display and/or broadcast the prompt for navigation. As another example, the acquisition module 810 and the feature determination module 820 may be integrated into one module.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated.

Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for navigation based on intersection coding, comprising:
at least one storage medium including a set of instructions; and
at least one processor in communication with the at least one storage medium, wherein when executing the set of instructions, the at least one processor is configured to cause the system to:
obtain a current location of a subject and navigation information;
determine, based on the current location and the navigation information, one or more road features associated with an upcoming intersection with respect to a current road segment;
determine, based on the one or more road features and a coding system, one or more navigation codes corresponding to the upcoming intersection; and
determine, based on the one or more navigation codes, a prompt for navigation associated with the upcoming intersection.

2. The system of claim 1, wherein the coding system provides a mapping relationship between a plurality of specific road features and a plurality of specific navigation codes, each of the plurality of specific navigation codes corresponds to a specific prompt for navigation, and the prompt for navigation is selected from the specific prompts.

3. The system of claim 1, wherein the one or more road features include at least one of:
one or more attributes of a road associated with the upcoming intersection;
a location relationship between a target road segment that the subject drives to and the current road segment;
a count of one or more interference roads on the left of the target road segment; or
a count of one or more interference roads on the right of the target road segment.

4. The system of claim 2, wherein the mapping relationship is determined by operations including:
determining a plurality of combinations of the plurality of specific road features; and
determining one of the plurality of specific navigation codes corresponding to each of the plurality of combinations of the plurality of specific road features.

5. The system of claim 3, wherein to determine the one or more road features, the at least one processor is configured to cause the system to:
for the upcoming intersection, determine, based on the current road segment, a multidirectional coordinate system;
determine a target region that the target road segment belongs to in the multidirectional coordinate system; and
determine, based on the target region, the one or more road features.

6. The system of claim 5, wherein to determine, based on the target region, the one or more road features, the at least one processor is configured to cause the system to:
determine a count of one or more road segments that the subject can drive to on either of two sides of the target road segment, respectively, as the count of interference roads on the left of the target road segment and the count of interference roads on the right of the target road segment, wherein the one or more road segments belongs to the target region or belongs to the target region and an adjacent region of the target region.

7. The system of claim 5, wherein the multidirectional coordinate system includes eight directions.

8. The system of claim 1, wherein the prompt for navigation includes at least one of an image, a voice, or a text.

9. The system of claim 1, wherein the at least one processor is further configured to cause the system to:
send signals to a client terminal to direct the client terminal to display the prompt for navigation.

10. The system of claim 1, wherein the at least one processor is further configured to cause the system to:
determine whether an attribute of the current road segment includes a roundabout entrance; and
in response to a determination that the attribute of the current road segment does not include the roundabout entrance, determine, based on the one or more road features and the coding system, the one or more navigation codes corresponding to the upcoming intersection.

11. The system of claim 1, wherein the at least one processor is further configured to cause the system to:
determine whether the navigation information includes a switch between a main road and a side road; and
in response to a determination that the navigation information includes the switch between the main road and the side road, adjust the prompt for navigation.

12. A method for navigation based on intersection coding, comprising:
obtaining a current location of a subject and navigation information;
determining, based on the current location and the navigation information, one or more road features associated with an upcoming intersection with respect to a current road segment;
determining, based on the one or more road features and a coding system, one or more navigation codes corresponding to the upcoming intersection; and
determining, based on the one or more navigation codes, a prompt for navigation associated with the upcoming intersection.

13. The method of claim 12, wherein the coding system provides a mapping relationship between a plurality of specific road features and a plurality of specific navigation codes, each of the plurality of specific navigation codes corresponds to a specific prompt for navigation, and the prompt for navigation is selected from the specific prompts.

14. The method of claim 12, wherein the one or more road features include at least one of:
one or more attributes of a road associated with the upcoming intersection;
a location relationship between a target road segment that the subject drives to and the current road segment;
a count of one or more interference roads on the left of the target road segment; or
a count of one or more interference roads on the right of the target road segment.

15. The method of claim 13, wherein the mapping relationship between the plurality of specific road features and the plurality of specific navigation codes is determined by:
determining a plurality of combinations of the plurality of specific road features; and
determining one of the plurality of specific navigation codes corresponding to each of the plurality of combinations of the plurality of specific road features.

16. The method of claim 14, wherein the determining the one or more road features includes:
for the upcoming intersection, determining, based on the current road segment, a multidirectional coordinate system;
determining a target region that the target road segment belongs to in the multidirectional coordinate system; and
determining, based on the target region, the one or more road features.

17. The method of claim 16, wherein the determining, based on the target region, the one or more road features includes:
determining a count of one or more road segments that the subject can drive to on either of two sides of the target road segment, respectively, as the count of interference roads on the left of the target road segment and the count of interference roads on the right of the target road segment, wherein the one or more road segments belongs to the target region or belongs to the target region and an adjacent region of the target region.

18-20. (canceled)

21. The method of claim 12, further comprising:
determining whether an attribute of the current road segment includes a roundabout entrance; and
in response to a determination that the attribute of the current road segment does not include the roundabout entrance, determining, based on the one or more road features and the coding system, the one or more navigation codes corresponding to the upcoming intersection.

22. The method of claim 12, further comprising:
determining whether the navigation information includes a switch between a main road and a side road; and
in response to a determination that the navigation information includes the switch between the main road and the side road, adjusting the prompt for navigation.

23. (canceled)

24. A non-transitory computer readable medium, comprising a set of instructions, wherein when executed by at least one processor, the set of instructions direct the at least one processor to perform acts of:
obtaining a current location of a subject and navigation information;
determining, based on the current location and the navigation information, one or more road features associated with an upcoming intersection with respect to a current road segment;
determining, based on the one or more road features and a coding system, one or more navigation codes corresponding to the upcoming intersection; and determining, based on the one or more navigation codes, a prompt for navigation associated with the upcoming intersection.
